(19) United States
(12) Patent Application Publication
(10) Pub. No.: US 2014/0001659 A1
(43) Pub. Date: Jan. 2, 2014

(54) MANUFACTURING METHOD FOR AN INPUT MODULE BY PLASTIC INJECTION MOLDING

(71) Applicant: ELAN MICROELECTRONICS CORPORATION, Hsin Chu (TW)

(72) Inventors: Wei-Ming CHEN, New Taipei City (TW); Wei-Wen YANG, New Taipei City (TW)

(73) Assignee: ELAN MICROELECTRONICS CORPORATION, Hsin Chu (TW)

(21) Appl. No.: 13/788,228

(22) Filed: Mar. 7, 2013

(30) Foreign Application Priority Data
Jun. 29, 2012 (TW) 101123415

(51) Int. Cl. B29D 11/00

(52) U.S. Cl. CPC B29D 11/00807
USPC 264/1.1

(57) ABSTRACT

A manufacturing method for an input module by plastic injection molding has the following steps. First, a sensing substrate is prepared and is put into a mold. A plastic is injection molded to form a cover lens or a supporting board on one side of the sensing substrate. Therefore, by injection molding to form and combine the structures together, the manufacturing process for the input module is simplified and the combination strength of the input module is also enhanced.

### BACKGROUND OF THE INVENTION

1. Field of the Invention

The present invention relates to a manufacturing method for an input module, especially to a manufacturing method for an input module by plastic injection molding.

2. Description of the Prior Arts

Input modules are mounted in notebook computers to substitute external mouse for users to control the cursor on the screen. By pressing relating positions on the input modules, the same functions as clicking the right and left mouse buttons are achieved.

With reference to FIGS. 29 and 30, an input module comprises a supporting board 60, a sensing substrate 70 and a cover lens 80. The supporting board 60 is made of metal or plastic. The sensing substrate 70 has a circuit and a physical switch 701 formed thereon. The cover lens 80 is made of glass or plastic. A conventional manufacturing method for an input module comprises acts of forming the supporting board 60, the sensing substrate 70 and the cover lens 80 individually and assembling the supporting board 60, the sensing substrate 70 and the cover lens 80 in sequence to form the input module.

However, the conventional manufacturing method for an input module has the following disadvantages:

1. Complicated manufacturing steps: Since the supporting board 60, the sensing substrate 70 and the cover lens 80 are formed individually and then assembled together, the manufacturing steps at least include individually forming and assembling those structures. Therefore, the manufacturing steps are complicated.

2. Weak binding strength: Because the supporting board 60, the sensing substrate 70 and the cover lens 80 are assembled together by adhering, only adhesive agent is attached between the adjacent structures to hold the adjacent structures together. Therefore, the binding strength between the structures is weak and the structures easily break away from each other.

3. Hardly-mendable binding strength: Since the supporting board 60, the sensing substrate 70 and the cover lens 80 are formed individually and then assembled together, gaps may be formed between the adjacent structures because of the tolerances resulting from the manufacturing process or the assembling process. The gaps weaken the binding strength such that the supporting board 60, the sensing substrate 70 and the cover lens 80 easier break away from each other.

To overcome the shortcomings, the present invention provides a manufacturing method for an input module by plastic injection molding to mitigate or obviate the aforementioned problems.

### SUMMARY OF THE INVENTION

The main objective of the present invention is to provide a manufacturing method for an input module by plastic injection molding.

In one aspect, the manufacturing method comprises acts of providing a sensing substrate, putting the sensing substrate into a cavity of a mold and closing the mold, injecting plastic into the cavity and integratedly forming a cover lens and a supporting board, wherein the cover lens and the supporting board are formed respectively on and cover two sides of the sensing substrate to constitute an input module, and opening the mold and taking out the input module.

In another aspect, the manufacturing method comprises acts of providing a semi-finished product, wherein the semi-finished product comprises a sensing substrate with two sides and a first outer panel, and the first outer panel is adhered securely to one of the sides of the sensing substrate to form the semi-finished product, putting the semi-finished product into a cavity of a mold and closing the mold, injecting plastic into the cavity and forming a second outer panel to cover the other one of the sides of the sensing substrate and to constitute an input module, wherein the first outer panel and the second outer panel are made of different materials, and opening the mold and taking out the input module.

Therefore, the supporting board or the cover lens no longer need to be pre-formed but are formed directly on the sensing substrate by injection molding. Then the steps to assemble the structure are eliminated. The assembling gaps caused tolerances resulting from the manufacturing process or the assembling process between the structures are also eliminated. Thus, the combining strength is enhanced to further ensure the quality of the input module.

Other objectives, advantages and novel features of the invention will become more apparent from the following detailed description when taken in conjunction with the accompanying drawings.

### BRIEF DESCRIPTION OF THE DRAWINGS

FIG. 1 is a flow chart of a first embodiment of a manufacturing method for an input module by plastic injection molding in accordance with the present invention;

FIG. 2 is an operational perspective view of the second step of the manufacturing method in FIG. 1;

FIG. 3 is an operational perspective view of the third step of the manufacturing method in FIG. 1;

FIG. 4 is an operational cross-sectional side view of the third step of the manufacturing method in FIG. 1;

FIG. 5 is an operational perspective view of the fourth step of the manufacturing method in FIG. 1;

FIG. 6 is an operational cross-sectional side view of the fourth step of the manufacturing method in FIG. 1;

FIG. 7 is an operational perspective view of the fifth step of the manufacturing method in FIG. 1;

FIG. 8 is an operational perspective view of the sixth step of the manufacturing method in FIG. 1;

FIG. 9 is a flow chart of a second embodiment of a manufacturing method for an input module by plastic injection molding in accordance with the present invention;

FIG. 10 is an operational perspective view of the fourth step of the manufacturing method in FIG. 9;

FIG. 11 is a flow chart of a third embodiment of a manufacturing method for an input module by plastic injection molding in accordance with the present invention;

FIG. 12 is a side view of the semi-finished product manufactured by the manufacturing method in FIG. 11;

FIG. 13 is an operational perspective view of the third step of the manufacturing method in FIG. 11;

FIG. 14 is an operational perspective view of the fourth step of the manufacturing method in FIG. 11;

FIG. 15 is an operational cross-sectional side view of the fourth step of the manufacturing method in FIG. 11;

FIG. 16 is an operational perspective view of the fifth step of the manufacturing method in FIG. 11;

FIG. 17 is an operational cross-sectional side view of the fifth step of the manufacturing method in FIG. 11;

FIG. 18 is a side view of the finished product manufactured by the manufacturing method in FIG. 11;

FIG. 19 is an operational perspective view of the sixth step of the manufacturing method in FIG. 11;

FIG. 20 is an operational perspective view of the seventh step of the manufacturing method in FIG. 11;

FIG. 21 is a flow chart of a fourth embodiment of a manufacturing method for an input module by plastic injection molding in accordance with the present invention;

FIG. 22 is an operational perspective view of the third step of the manufacturing method in FIG. 21;

FIG. 23 is an operational perspective view of the fourth step of the manufacturing method in FIG. 21;

FIG. 24 is an operational cross-sectional side view of the fourth step of the manufacturing method in FIG. 21;

FIG. 25 is an operational perspective view of the fifth step of the manufacturing method in FIG. 21;

FIG. 26 is an operational cross-sectional side view of the fifth step of the manufacturing method in FIG. 21;

FIG. 27 is an operational perspective view of the sixth step of the manufacturing method in FIG. 21;

FIG. 28 is an operational perspective view of the seventh step of the manufacturing method in FIG. 21;

FIG. 29 is a perspective view of a conventional input module in accordance with the prior art; and

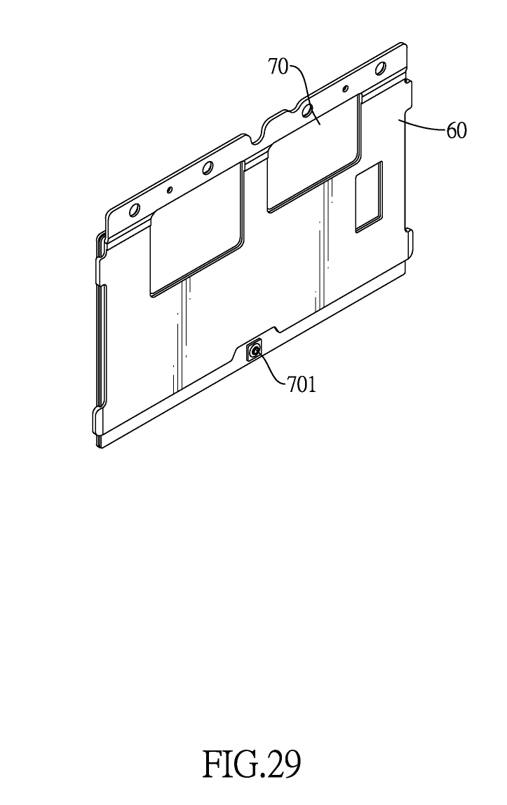

FIG. 30 is an exploded perspective view of the conventional input module in FIG. 29.

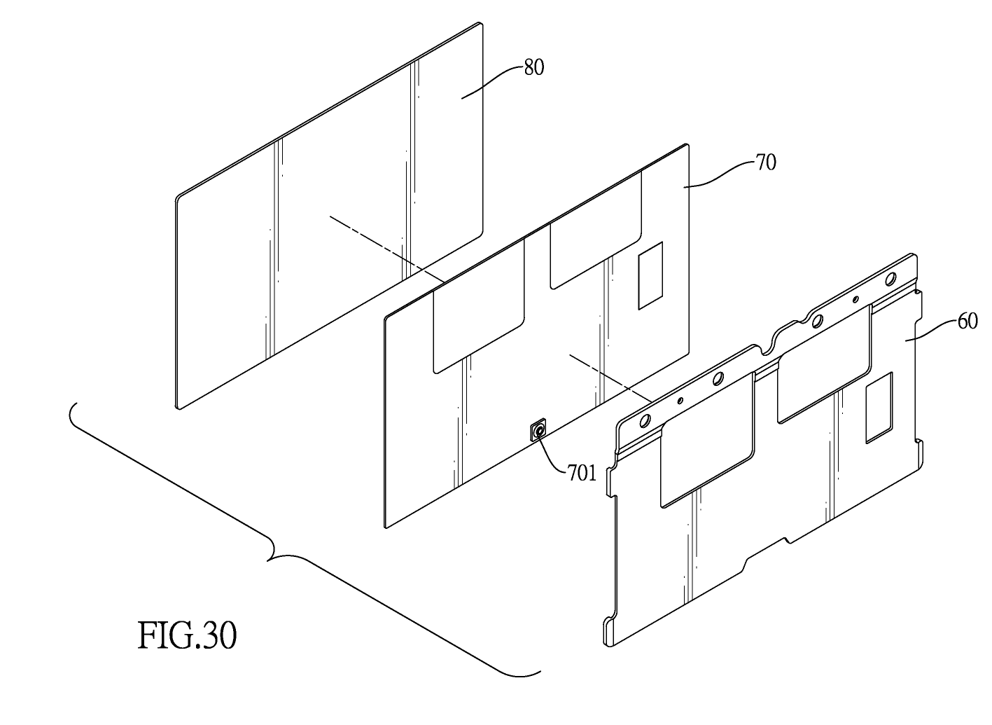

### DETAILED DESCRIPTION OF THE PREFERRED EMBODIMENTS

A manufacturing method for an input module by plastic injection molding in accordance with the present invention uses molds to form the input module. With different embodiments, the molds have corresponding recesses and structures to keep the exposed circuit on the sensing substrate from being covered by the plastic. The gates on the molds as shown hereinafter are illustrative only and are not intended to be limited thereto. A person skilled in the art may alter the position of the gates on the mold without departing from the scope of the manufacturing method in accordance with the present invention. The plastic as mentioned hereinafter may be carbon fibers, compounded plastic and so on and is not intended to be limited thereto.

### Embodiment I

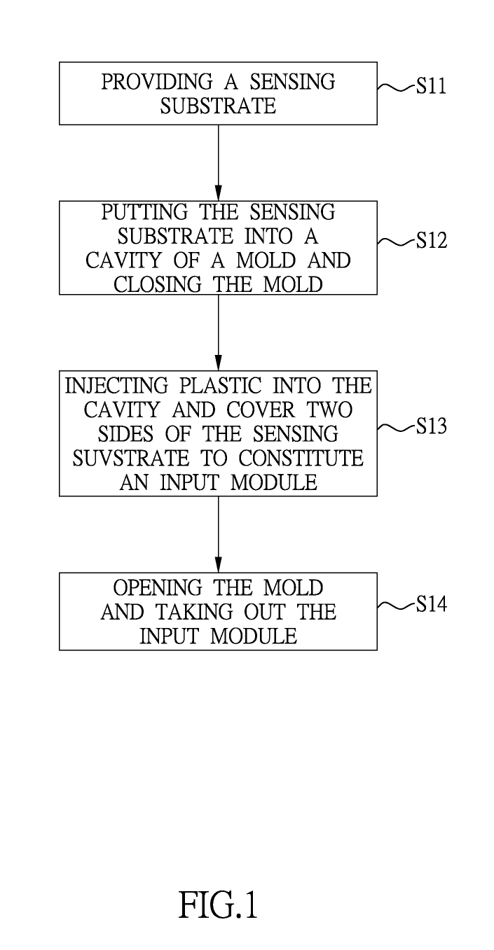

With reference to FIG. 1, a first embodiment of a manufacturing method for an input module by plastic injection molding in accordance with the present invention comprises steps as follows.

A sensing substrate 10 is provided (S11). The sensing substrate 10 has an internal circuit formed thereon that does not need to be exposed. The internal circuit is coated in advance with heat insulation glue or other protective materials to be protected from damage by high temperature in subsequent steps. The sensing substrate 10 has an external circuit 11 and a physical switch 12 formed thereon that need to be exposed.

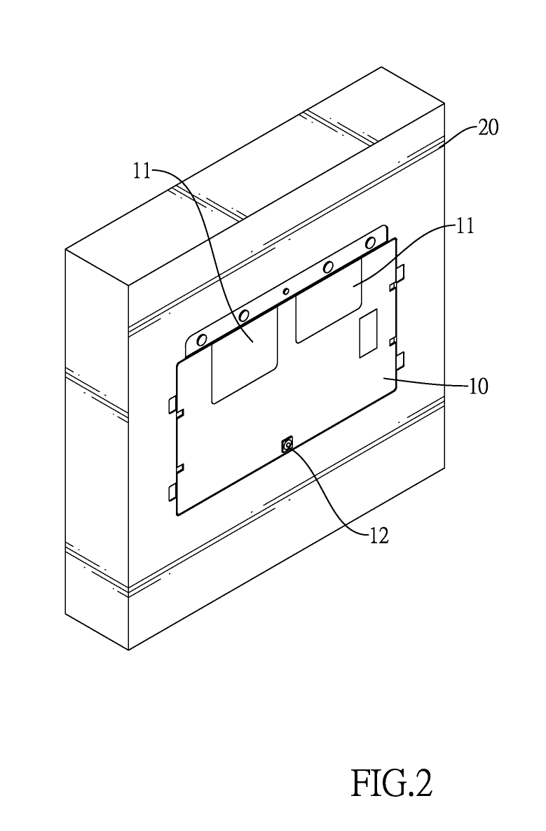

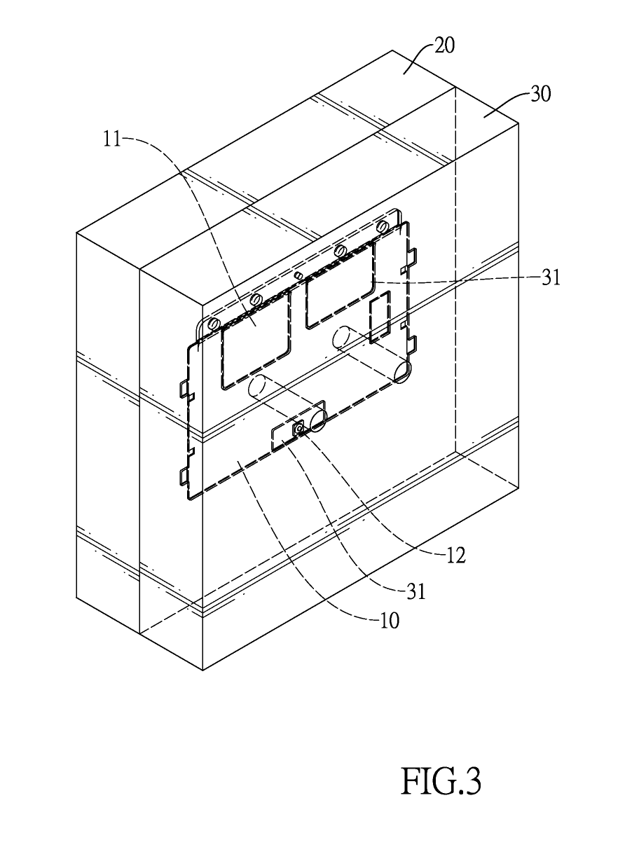

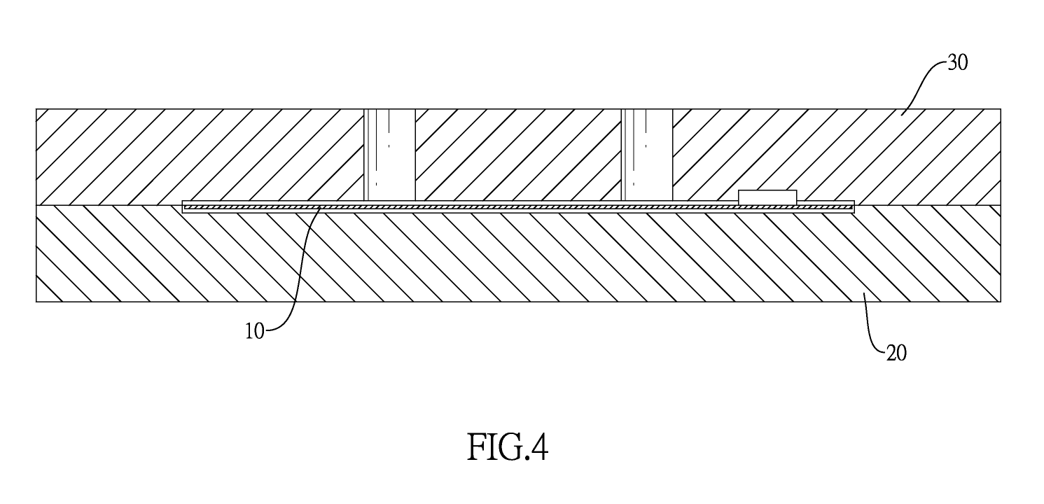

The sensing substrate 10 is then put into a cavity of a mold and the mold is closed as shown in FIGS. 2 to 4 (S12). In a preferred embodiment, the mold has a recess 31 or a separating unit formed therein to correspond to the external circuit 11 and the physical switch 12 on the sensing substrate 10. Furthermore, the mold comprises a first mold 20 and a second mold 30. The first mold 20 has a cavity. The cavity of the first mold 20 has a shape and a size that correspond to the shape and the size of the sensing substrate 10. The recess 31 is formed in the second mold 30 and corresponds to the external circuit 11 and the physical switch 12 on the sensing substrate 10. When the second mold 30 is pressed fit to the first mold 20, the recess 31 aligns with the external circuit 11 and the physical switch 12. Optionally, the separating unit is formed in the second mold 30. When the second mold 30 is pressed fit to the first mold 20, the separating unit aligns with the external circuit 11 and the physical switch 12.

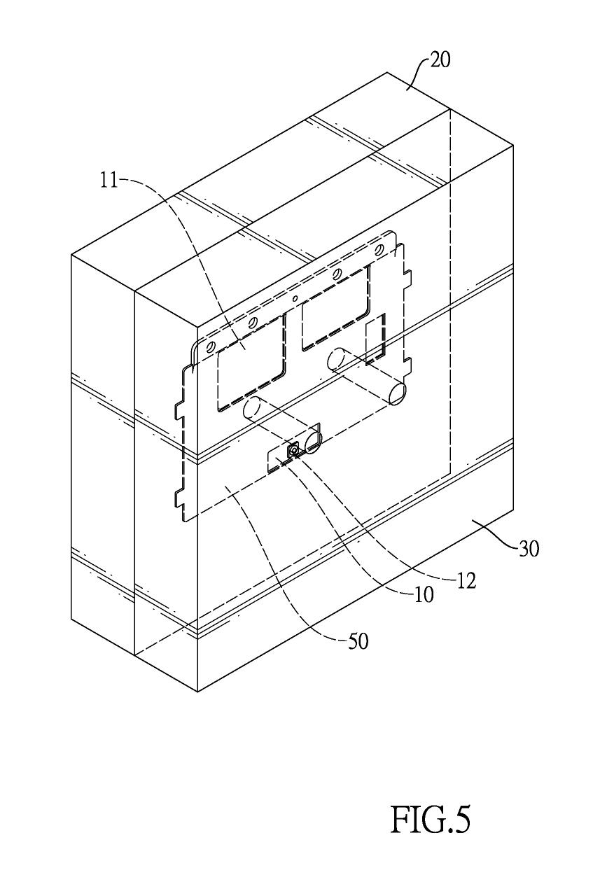

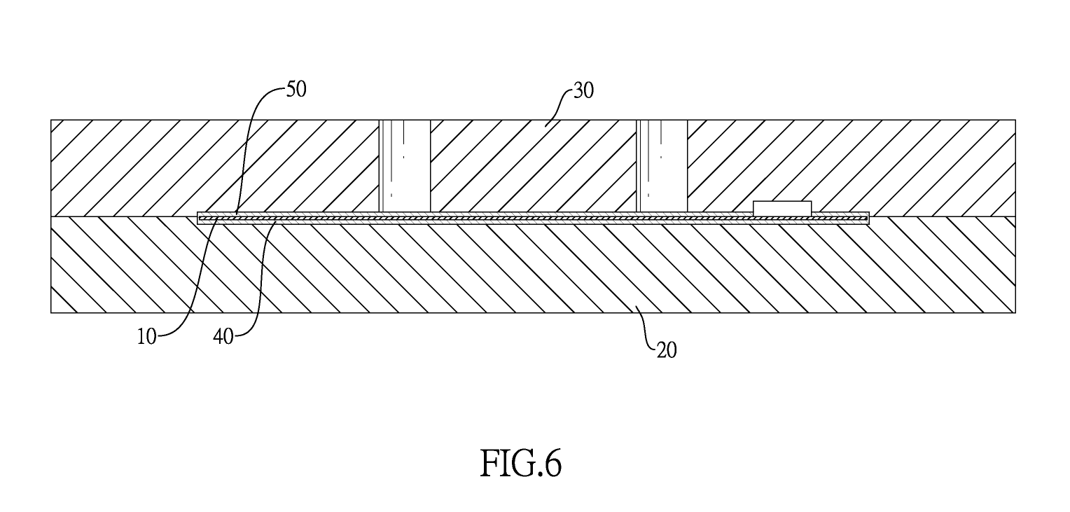

A plastic is injected into the cavity of the mold and a cover lens 40 and a supporting board 50 are formed integratedly to cover the sensing substrate 10 as shown in FIGS. 5 and 6. Then the sensing substrate 10, the cover lens 40 and the supporting board 50 constitute the input module 100 (S13). In the preferred embodiment, the plastic is injected into the cavity between the first and second molds 20, 30. Since the external circuit 11 and the physical switch 12 on the sensing substrate 10 are covered by the recess or the separating unit, the supporting board 50 is not formed on the external circuit 11 and the physical switch 12 when the plastic is injected. Therefore, the external circuit 11 and the physical switch 12 are exposed.

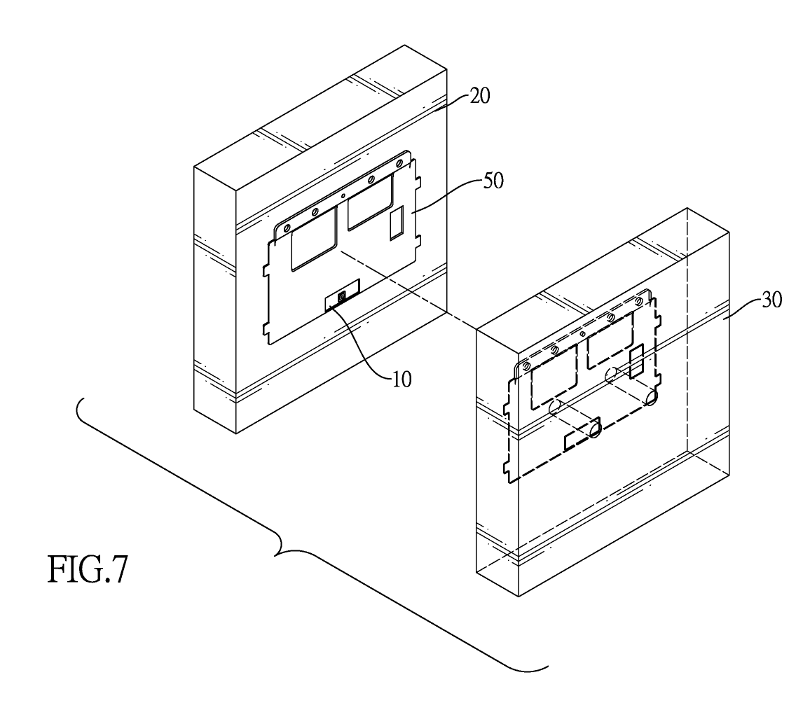

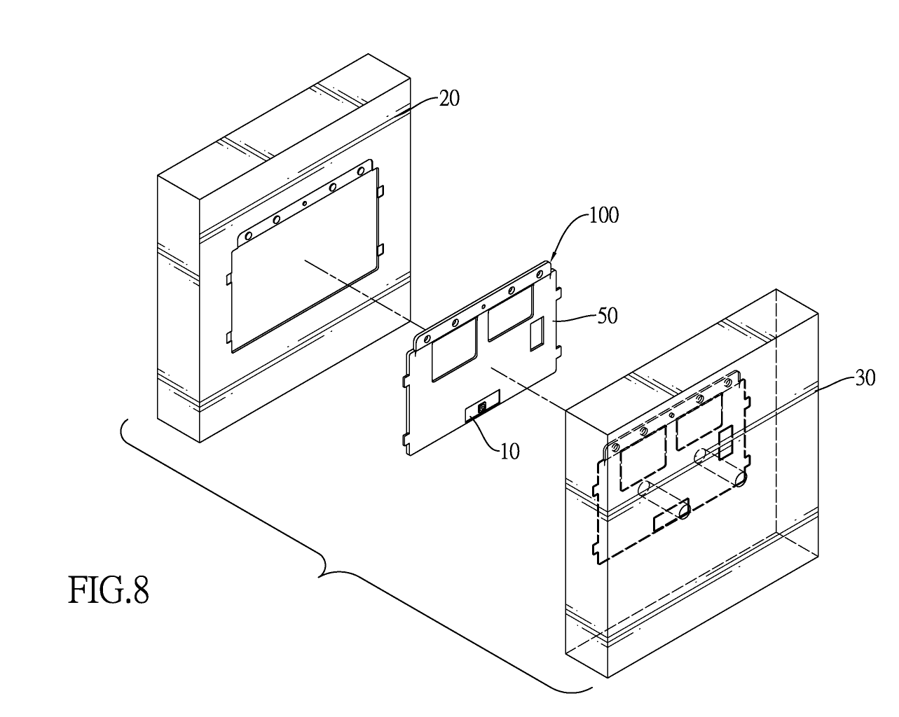

Finally, the mold is opened and the input module 100 is taken out of the mold as shown in FIGS. 7 and 8 (S14).

### Embodiment II

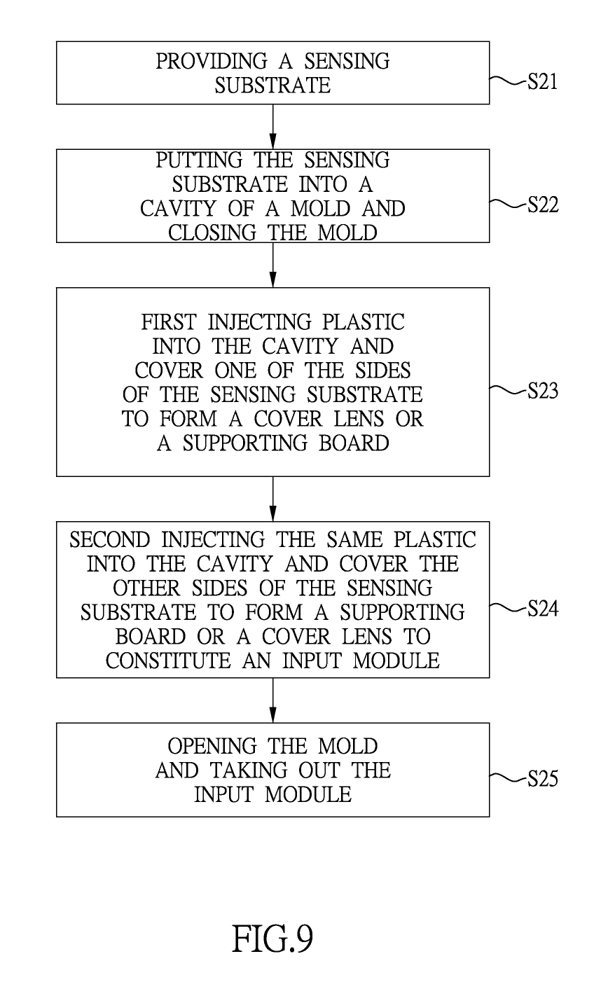

With reference to FIG. 9, a second embodiment of a manufacturing method for an input module by plastic injection molding in accordance with the present invention comprises steps as follows.

A sensing substrate 10 is provided (S21). The sensing substrate 10 has two sides and an internal circuit formed thereon that does not need to be exposed. The internal circuit is coated in advance with heat insulation glue or other protective materials to be protected from damage by high temperature in subsequent steps. The sensing substrate 10 has an external circuit 11 that needs to be exposed and a physical switch 12 formed thereon.

The sensing substrate 10 is then put into a cavity of a mold and the mold is closed as shown in FIGS. 2 to 4 (S22). In a preferred embodiment, the mold has a recess 31 or a separating unit formed therein to correspond to the external circuit 11 and the physical switch 12 on the sensing substrate 10. Furthermore, the mold comprises a first mold 20 and a second mold 30. The first mold 20 has a cavity. The cavity of the first mold 20 has a shape and a size that correspond to the shape and the size of the sensing substrate 10. The recess 31 is formed in the second mold 30 and corresponds to the external circuit 11 and the physical switch 12 on the sensing substrate 10. When the second mold 30 is pressed fit to the first mold 20, the recess 31 aligns with the external circuit 11 and the physical switch 12. Optionally, the separating unit is formed in the second mold 30. When the second mold 30 is pressed fit to the first mold 20, the separating unit aligns with the external circuit 11 and the physical switch 12.

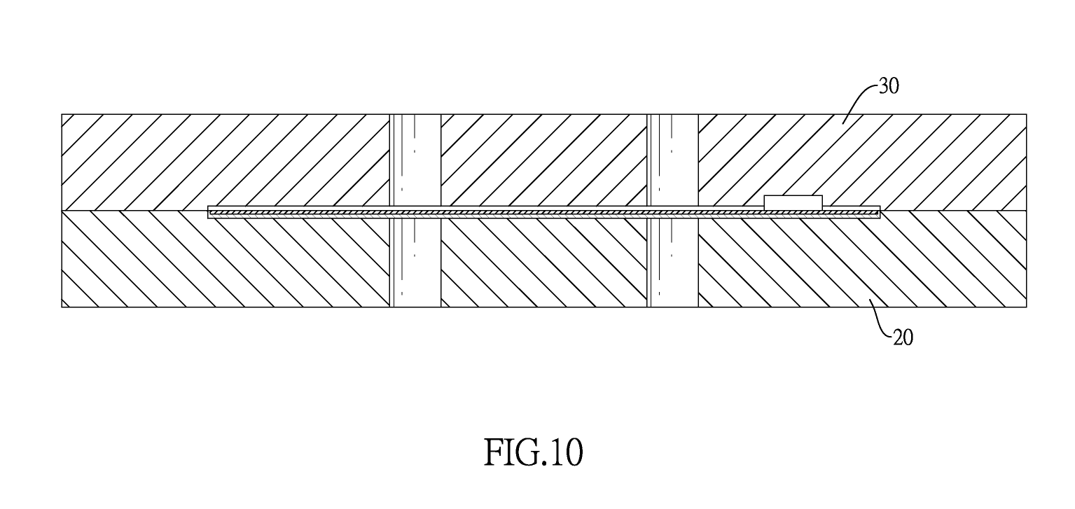

A first plastic is injected into the cavity of the mold and a cover lens 40 or a supporting board 50 is formed to cover one of the sides of the sensing substrate 10 as shown in FIG. 10. In the preferred embodiment, the first plastic is injected into the cavity between the first and the second molds 20, 30.

Then a second plastic, which is a different plastic from the first plastic, is injected into the cavity of the mold and a supporting board 50 or a cover lens 40 is formed to cover the other one of the sides of the sensing substrate 10. Then the sensing substrate 10, the cover lens 40 and the supporting board 50 constitute the input module 100 as shown in FIG. 6. In the preferred embodiment, the second plastic is injected into the cavity between the first and second molds 20, 30. In the preferred embodiment, the first plastic is injected to form the cover lens 40, and the second plastic is injected to form, but not limited to, the supporting board 50. Furthermore, since the external circuit 11 and the physical switch 12 on the sensing substrate 10 are covered by the recess or the separating unit, the supporting board 50 is not formed on the external circuit 11 and the physical switch 12 when the plastic is injected. Therefore, the external circuit 11 and the physical switch 12 are exposed.

Finally, the mold is opened and the input module 100 is taken out of the mold as shown in FIGS. 7 and 8 (S25).

### Embodiment III

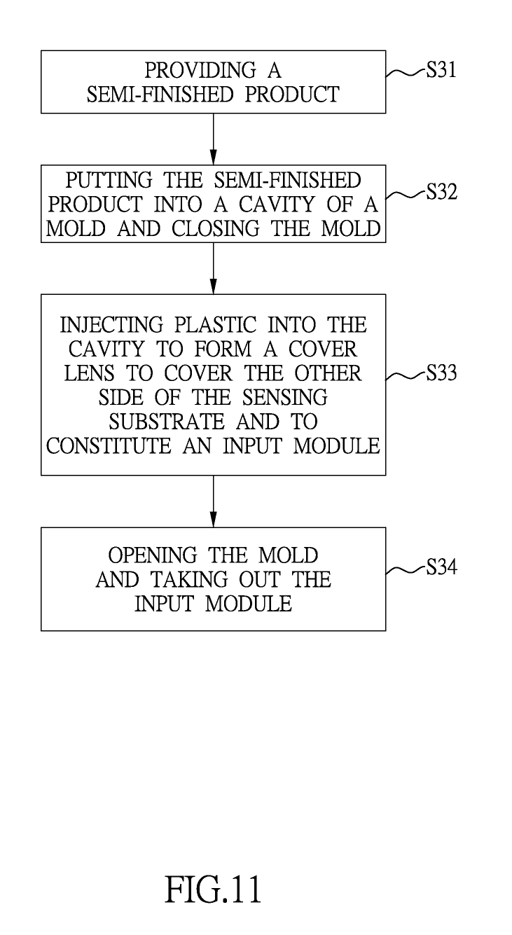

With reference to FIG. 11, a third embodiment of a manufacturing method for an input module by plastic injection molding in accordance with the present invention comprises steps as follows.

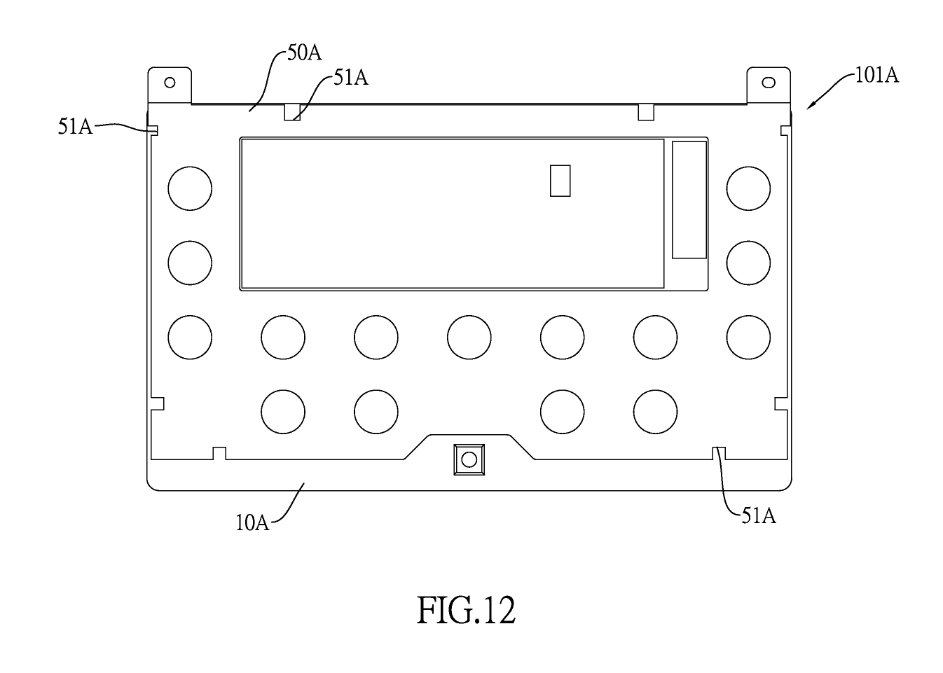

A semi-finished product 101A is provided (S31). The semi-finished product 101A comprises a sensing substrate 10A with two sides and a supporting board 50A. The supporting board 50A is adhered securely to one of the sides of the sensing substrate 10A to form the semi-finished product 101A. The supporting board 50A is made of metal and has multiple notches 51A. The notches 51A are formed on edges of the supporting board 50A as shown in FIG. 12. The sensing substrate 10A has an internal circuit formed thereon that does not need to be exposed. The internal circuit is coated in advance with heat insulation glue or other protective materials to be protected from damage by high temperature in subsequent steps.

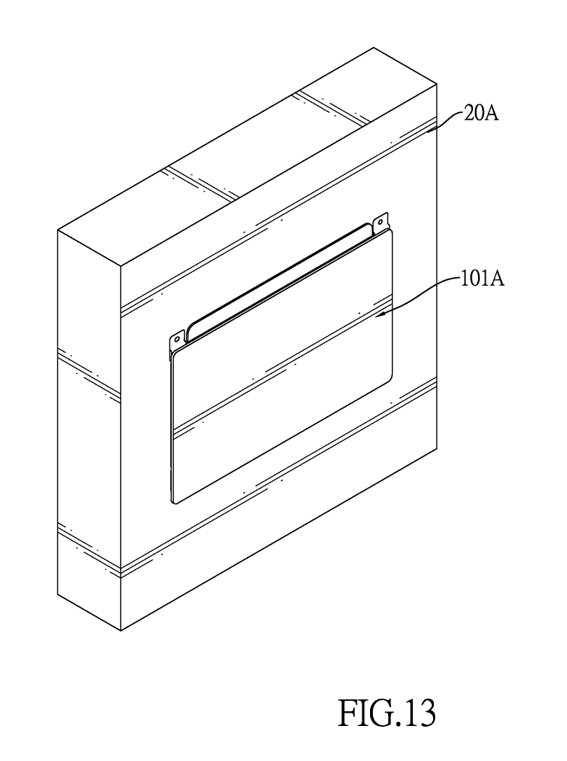

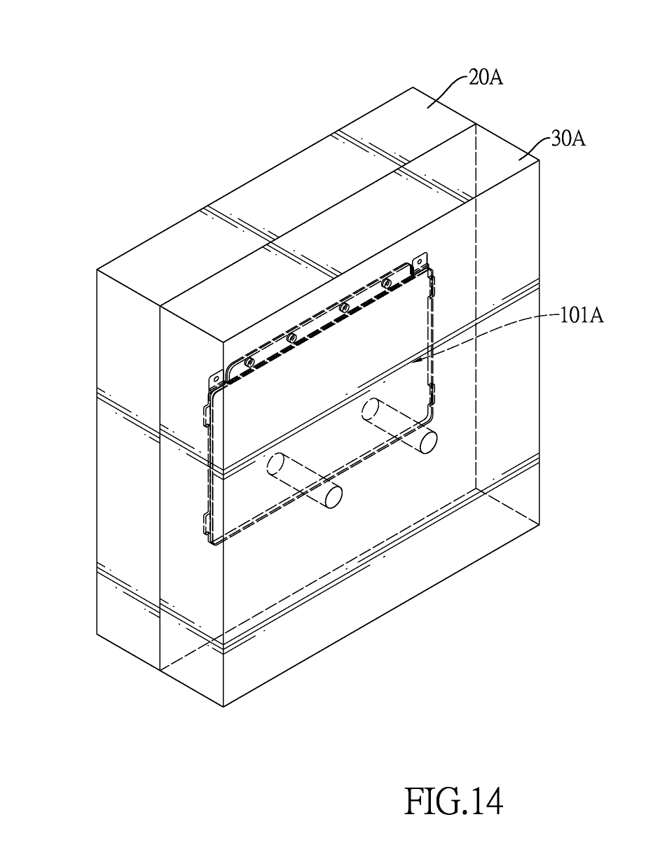

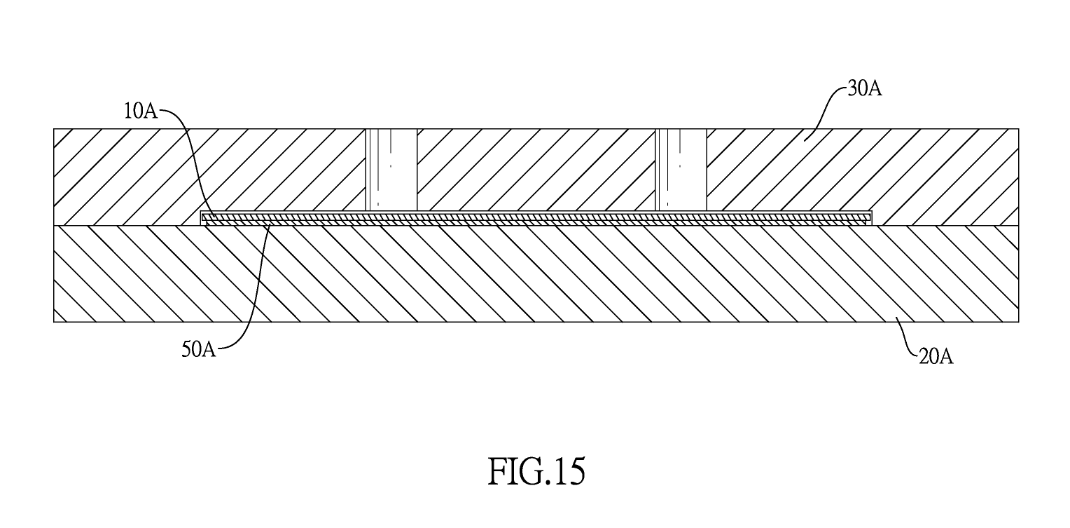

The semi-finished product 101A is then put into a cavity of a mold and the mold is closed as shown in FIGS. 13 to 15 (S32). In a preferred embodiment, the mold comprises a first mold 20A and a second 30A. The first mold 20A has a cavity. The cavity of the first mold 20A has a shape and a size that correspond to the shape and the size of the semi-finished product 101A.

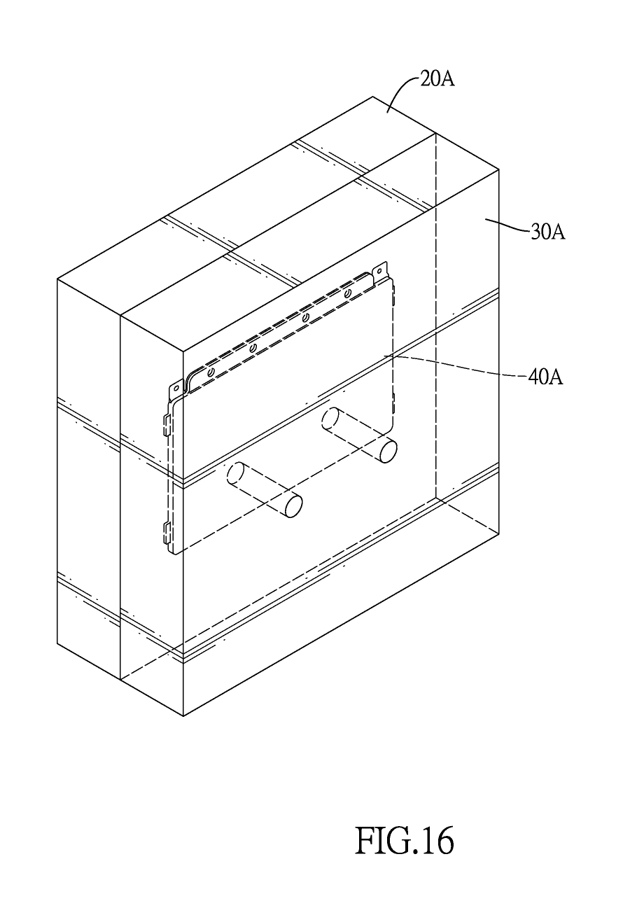

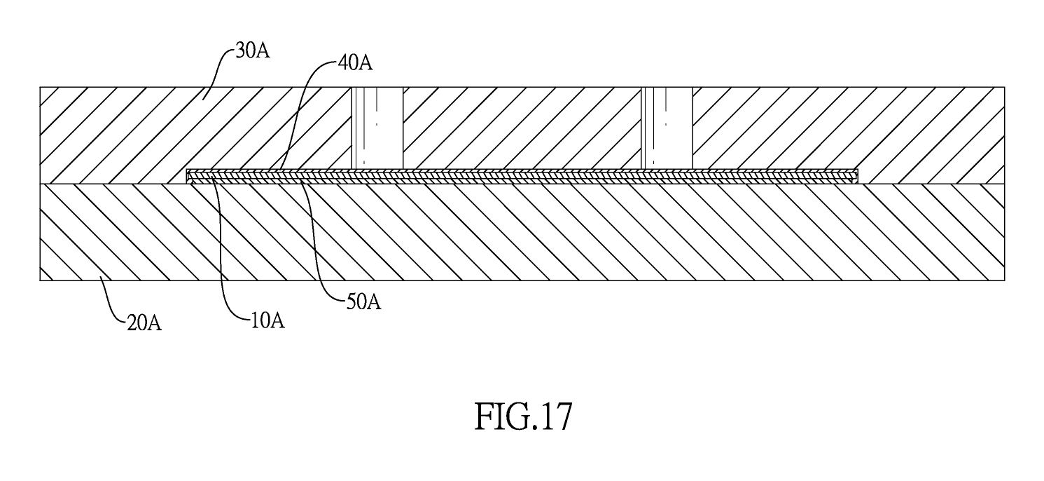

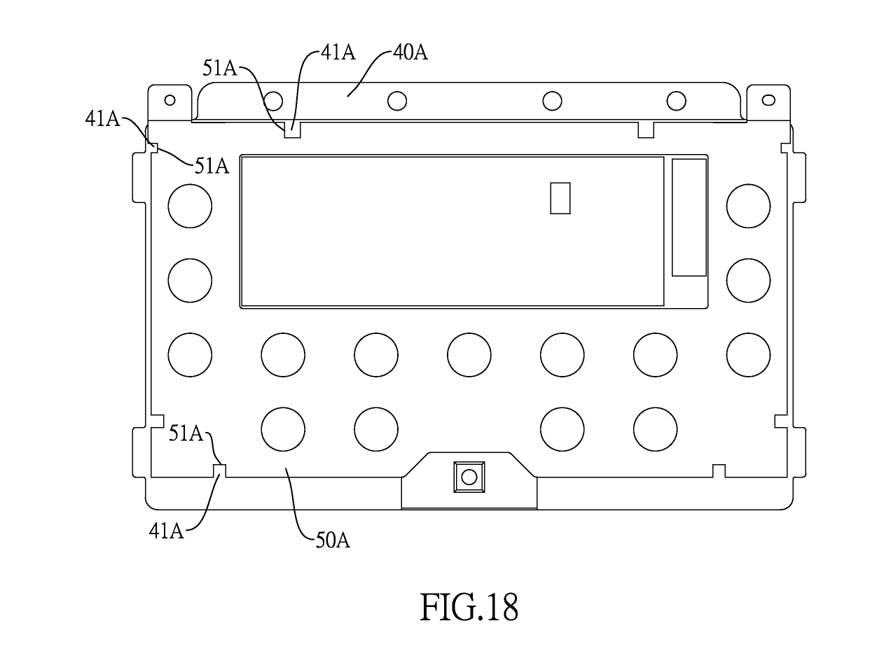

A plastic is injected into the cavity of the mold and a cover lens 40A is formed to cover the other one of the sides of the sensing substrate 10A, to extend to edges of the sensing substrate 10A and to combine with the supporting board 50A as shown in FIGS. 16 and 17. Then the sensing substrate 10A, the cover lens 40A and the supporting board 50A constitute the input module 100A (S33). In the preferred embodiment, the plastic is injected into the cavity between the first and second molds 20A, 30A. The cover lens 40A has multiple protrusions 41A. The protrusions 41A are formed on the edges of the cover lens 40A and engage with the notches 51A on the supporting board 50A to enhance the binding strength as shown in FIG. 18.

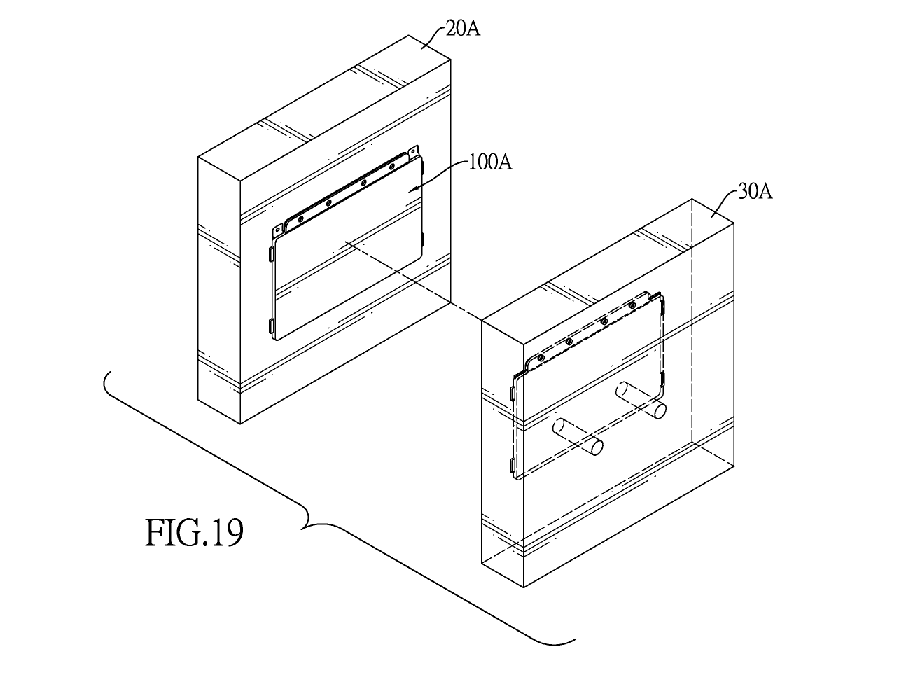

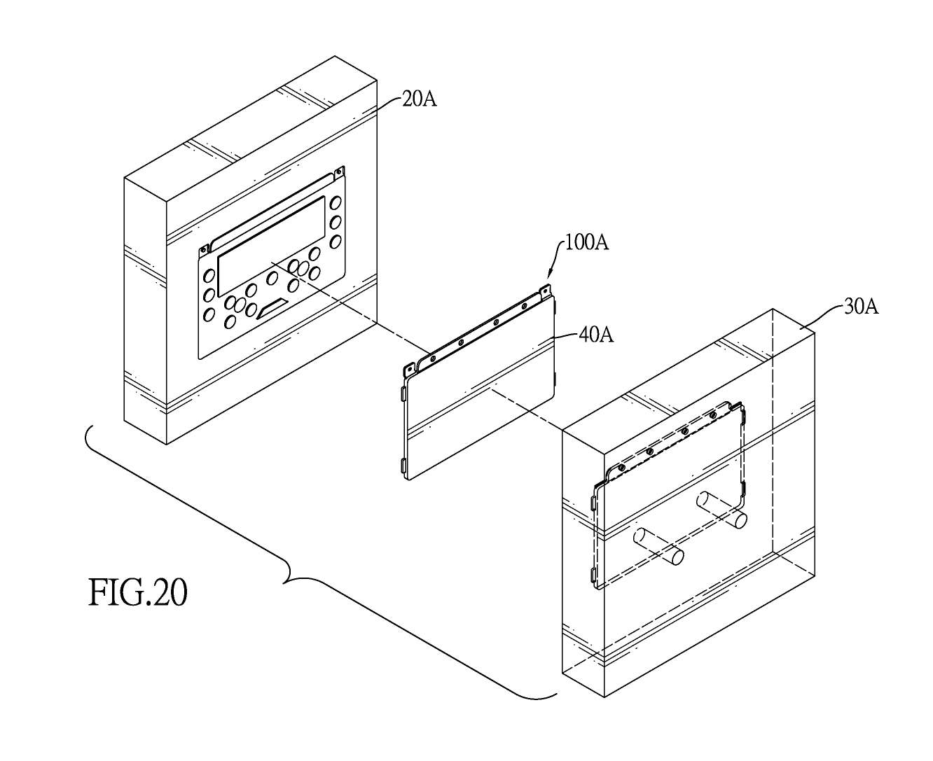

Finally, the mold is opened and the input module 100A is taken out of the mold as shown in FIGS. 19 and 20 (S34).

### Embodiment IV

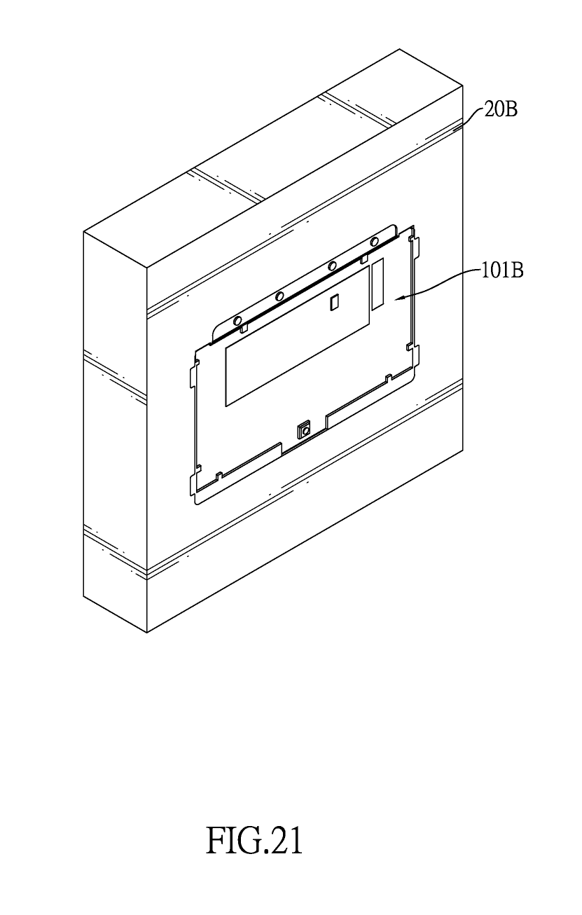

With reference to FIG. 21, a fourth embodiment of a manufacturing method for an input module by plastic injection molding in accordance with the present invention comprises steps as follows.

A semi-finished product 101B is provided (S41). The semi-finished product 101B comprises a sensing substrate 10B with two sides and a cover lens 40B. The cover lens 40B is adhered securely to one of the sides of the sensing substrate 10B to form the semi-finished product 101B. The cover lens 40B is made of metal or glass. The sensing substrate 10B has an internal circuit formed thereon that does not need to be exposed. The internal circuit is coated in advance with heat insulation glue or other protective materials to be protected from damage by high temperature in subsequent steps. The sensing substrate 10B has an external circuit 11B that needs to be exposed and a physical switch 12B formed thereon.

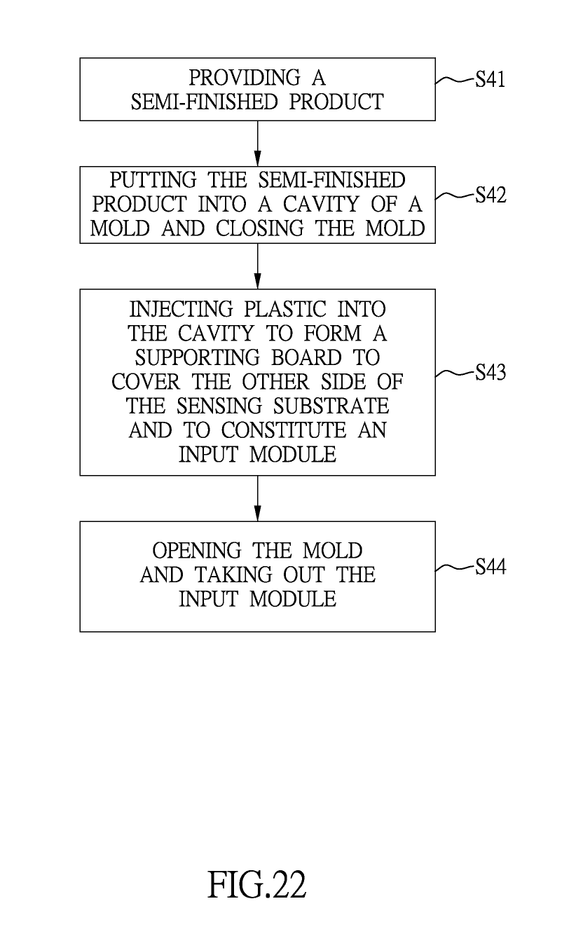

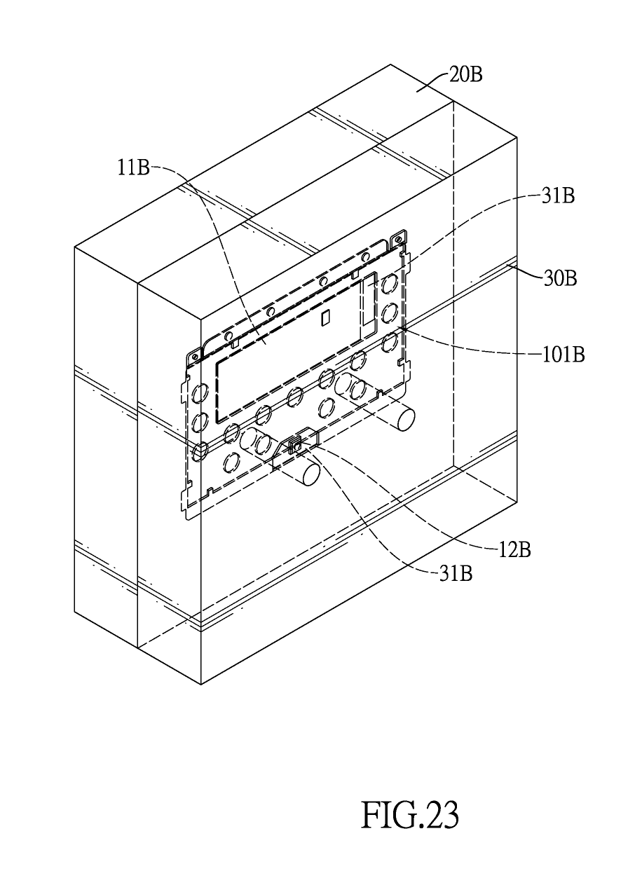

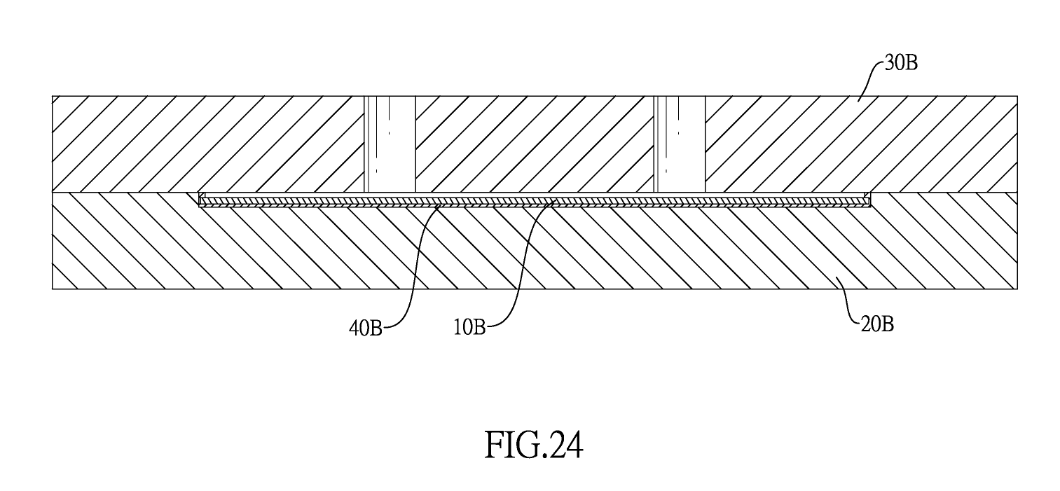

The semi-finished product 101B is then put into a cavity of a mold and the mold is closed as shown in FIGS. 22 to 24 (S42). In a preferred embodiment, the mold has a recess 31B or a separating unit formed therein to correspond to the external circuit 11B and the physical switch 12B on the sensing substrate 10B. Furthermore, the mold comprises a first mold 20B and a second mold 30B. The first mold 20B has a cavity. The cavity of the first mold 20B has a shape and a size that correspond to the shape and the size of the semi-finished product 101B. The recess 31B is formed in the second mold 30B and corresponds to the external circuit 11B and the physical switch 12B on the sensing substrate 10B. When the second mold 30B is pressed fit to the first mold 20B, the recess 31B aligns with the external circuit 11B and the physical switch 12B. Optionally, the separating unit is formed in the second mold 30B. When the second mold 30B is pressed fit to the first mold 20B, the separating unit aligns with the external circuit 11B and the physical switch 12B.

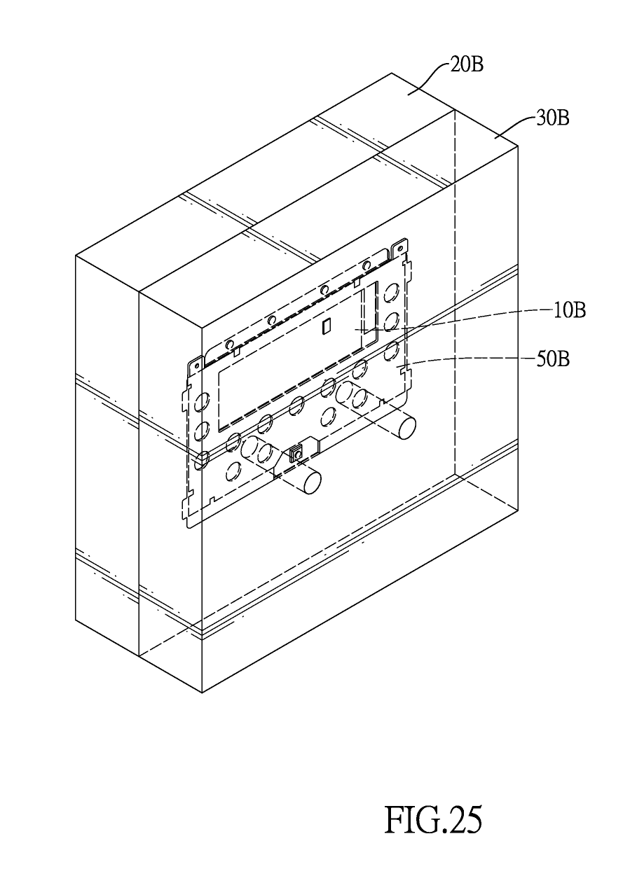

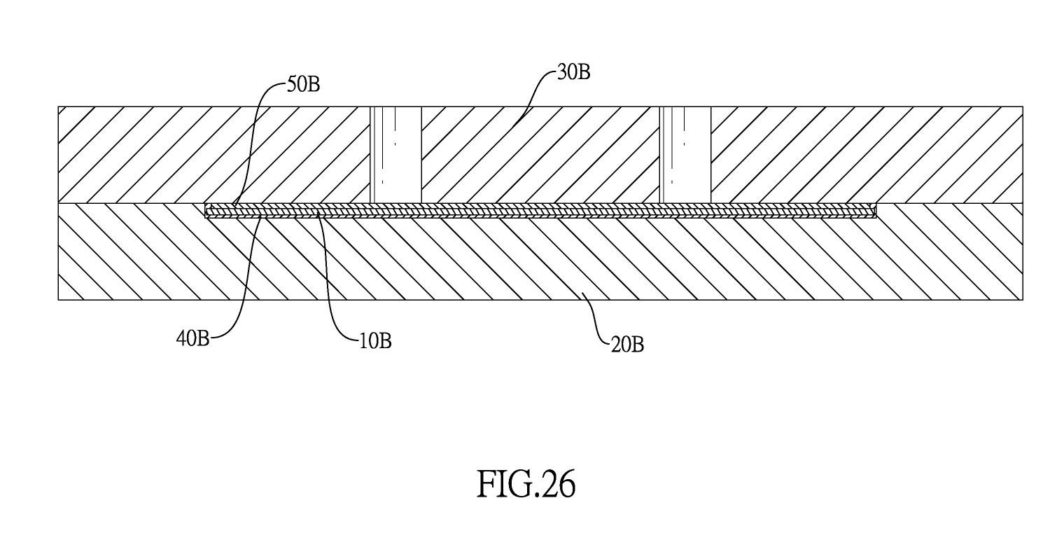

A plastic is injected into the cavity of the mold and a supporting board 50B is formed to cover the other one of the sides of the sensing substrate 10B, to extend to edges of the sensing substrate 10B and to combine with the cover lens 40B as shown in FIGS. 25 and 26. Then the sensing substrate 10B, the cover lens 40B and the supporting board 50B constitute the input module 100B (S43). In the preferred embodiment, the plastic is injected into the cavity between the first and second molds 20B, 30B. Furthermore, since the external circuit 11B and the physical switch 12B on the sensing substrate 10B are covered by the recess or the separating unit, the supporting board 50B is not formed on the external circuit 11B and the physical switch 12B when the plastic is injected. Therefore, the external circuit 11B and the physical switch 12B are exposed. The cover lens 40B and the supporting board 50B in this embodiment may also have corresponding notches and protrusions to enhance the binding strength.

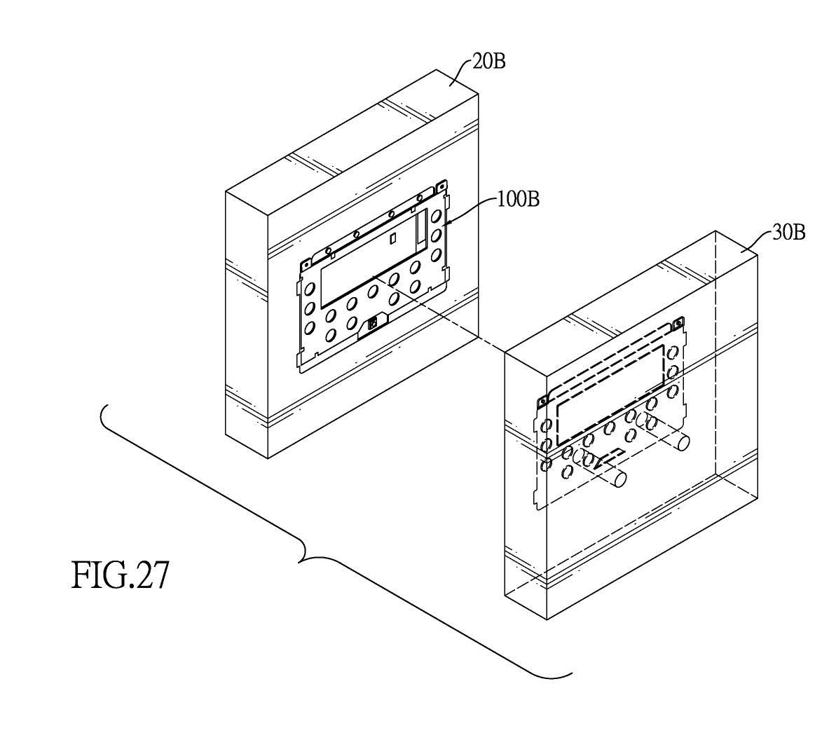

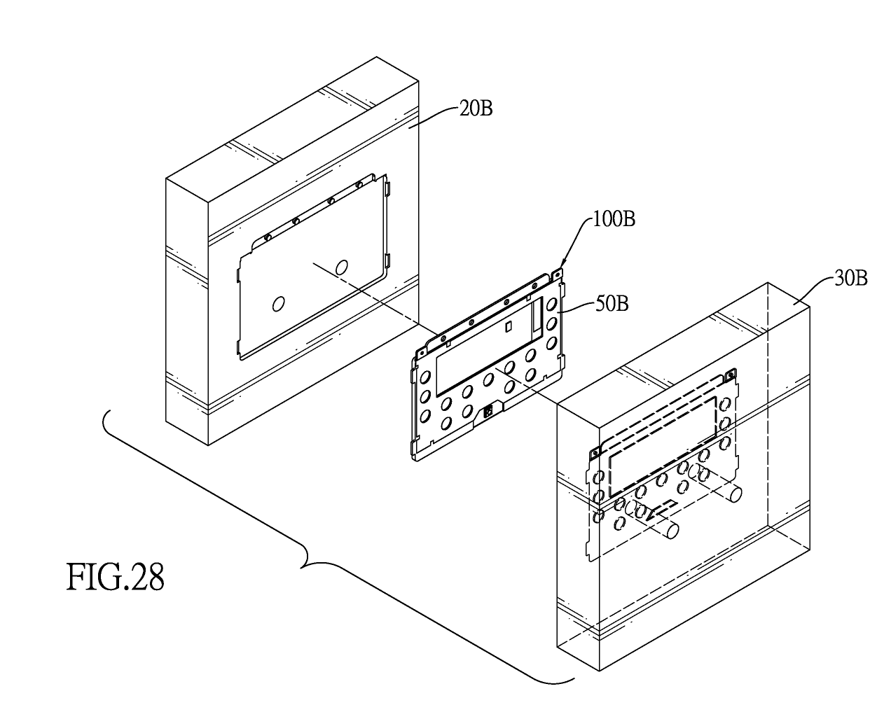

Finally, the mold is opened and the input module 100B is taken out of the mold as shown in FIGS. 27 and 28 (S44).

The manufacturing method as described has the following advantages:

1. At least one of the supporting board and the cover lens is made by injecting mold to combine with the sensing substrate so that the forming and combining steps are finished in the same process. Therefore, the steps of the manufacturing method are effectively reduced.

2. When one of the supporting board and the cover lens is made by injecting mold to combine with the sensing substrate and the other element, the forming and combining steps are finished in the same process to enhance the binding strength.

3. With the plastic flowing during the injection molding steps, the assembling gaps between the elements are filled with the plastic to further enhance the binding strength of the input module.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A manufacturing method for an input module by plastic injection molding comprising steps of:
providing a sensing substrate;
putting the sensing substrate into a cavity of a mold and closing the mold;
injecting plastic into the cavity and integratedly forming a cover lens and a supporting board, wherein the cover lens and the supporting board are formed respectively on and cover two sides of the sensing substrate to constitute an input module; and
opening the mold and taking out the input module.

2. The manufacturing method as claimed in claim 1, wherein in the step of injecting plastic, the same plastic is used to form the supporting board and the cover lens.

3. The manufacturing method as claimed in claim 1, wherein in the step of injecting plastic, the cover lens is injection molded first and then the supporting board is injection molded.

4. The manufacturing method as claimed in claim 1, wherein in the step of injecting plastic, the supporting board is injection molded first and then the cover lens is injection molded.

5. The manufacturing method as claimed in claim 1, wherein in the step of providing sensing a substrate, the sensing substrate has an internal circuit formed thereon that does not need to be exposed and is coated in advance with heat insulation glue.

6. The manufacturing method as claimed in claim 1, wherein
in the step of providing a sensing substrate, the sensing substrate has an external circuit and a physical switch formed thereon that need to be exposed; and
in the step of closing the mold, the mold has a recess formed therein to correspond to the external circuit and the physical switch on the sensing substrate.

7. The manufacturing method as claimed in claim 1, wherein
in the step of providing a sensing substrate, the sensing substrate has an external circuit and a physical switch formed thereon that need to be exposed; and
in the step of closing the mold, the mold has a separating unit formed therein to correspond to the external circuit and the physical switch on the sensing substrate.

8. A manufacturing method for an input module by plastic injection molding comprising steps of:
providing a semi-finished product, wherein the semi-finished product comprises a sensing substrate with two sides and a first outer panel, and the first outer panel is adhered securely to one of the sides of the sensing substrate to form the semi-finished product;
putting the semi-finished product into a cavity of a mold and closing the mold;
injecting plastic into the cavity and forming a second outer panel to cover the other one of the sides of the sensing substrate and to constitute an input module, wherein the first outer panel and the second outer panel are made of different materials; and
opening the mold and taking out the input module.

9. The manufacturing method as claimed in claim 8, wherein
in the step of providing a semi-finished product, the first outer panel is a supporting board; and
in the step of injecting plastic, the second outer panel is a cover lens.

10. The manufacturing method as claimed in claim 9, wherein the supporting board is made of metal.

11. The manufacturing method as claimed in claim 8, wherein
in the step of providing a semi-finished product, the first outer panel is a cover lens; and
in the step of injecting plastic, the second outer panel is a supporting board.

12. The manufacturing method as claimed in claim 11, wherein the cover lens is made of metal or glass.

13. The manufacturing method as claimed in claim 11, wherein
in the step of providing a semi-finished product, the sensing substrate has an external circuit and a physical switch formed thereon that need to be exposed; and
in the step of closing the mold, the mold has a recess formed therein to correspond to the external circuit and the physical switch on the sensing substrate.

14. The manufacturing method as claimed in claims 11, wherein
in the step of providing a semi-finished product, the sensing substrate has an external circuit and a physical switch formed thereon that need to be exposed; and
in the step of closing the mold, the mold has a separating unit formed therein to correspond to the external circuit and the physical switch on the sensing substrate.

15. The manufacturing method as claimed in any claim of claims 8, wherein
in the step of providing a semi-finished product, the first outer panel has multiple notches formed on edges of the first outer panel; and
in the step of injecting plastic, the second outer panel has multiple protrusions formed on edges of the second outer panel and engaging with the notches on the first outer panel.

16. The manufacturing method as claimed in any claim of claims 8, wherein in the step of providing a semi-finished product, the sensing substrate has an internal circuit formed thereon that does not need to be exposed and is coated in advance with heat insulation glue.
